(19) United States
(12) Patent Application Publication
(10) Pub. No.: US 2015/0313361 A1
(43) Pub. Date: Nov. 5, 2015

(54) COATED ARTICLE AND METHOD OF MANUFACTURING THEREOF

(71) Applicant: North Carolina State University, Raleigh, NC (US)

(72) Inventor: Aidan J. Moyle, Auckland (NZ)

(21) Appl. No.: 14/268,096

(22) Filed: May 2, 2014

(51) Int. Cl. A47B 96/20; B05D 1/32

(52) U.S. Cl. CPC A47B 96/205; B05D 1/32

(57) ABSTRACT

A method of manufacturing a coated article includes providing a substrate, positioning a spacer adjacent the substrate, applying a polymer coating to the spacer and the substrate, and removing the polymer-coated spacer to expose an uncoated portion of the substrate.

### FIELD OF THE INVENTION

The present invention relates to coated articles, and more particularly to a method of manufacturing such coated articles.

### BACKGROUND OF THE INVENTION

Substrates (e.g., wood, metals, etc.) are sometimes coated (e.g., with a polymer) to protect the substrate or to provide a different exterior that is viewed and touched by a consumer. A consumer product including such a coated substrate, however, can present difficulties in both manufacturing and assembling the consumer product.

### SUMMARY OF THE INVENTION

The invention provides, in one aspect, a method of manufacturing a coated article including providing a substrate, positioning a spacer adjacent the substrate, applying a polymer coating to the spacer and the substrate, and removing the polymer-coated spacer to expose an uncoated portion of the substrate.

The invention provides, in another aspect, a coated article including a first substrate, a second substrate, and a polymer coating covering the first substrate and the second substrate. A web of the polymer coating interconnects the first substrate and the second substrate.

Other aspects of the invention will become apparent by consideration of the detailed description and accompanying drawings.

### BRIEF DESCRIPTION OF THE DRAWINGS

FIG. 1 is a front perspective view of a coated article in accordance with an embodiment of the invention.

FIG. 2 is a rear perspective view of the coated article of FIG. 1.

FIGS. 3-8 illustrate a method of manufacturing the coated article of FIG. 1 in accordance with an embodiment of the invention.

FIG. 9 is a perspective view of a step in an assembly process for the coated article of FIG. 1.

FIG. 10 is a perspective view of another step in the assembly process for the coated article of FIG. 1.

FIG. 11 is a perspective view of a kit including a plurality of coated articles, like that shown in FIG. 1, prior to assembly.

FIG. 12 is a perspective view of one step in an assembly process for the coated articles of FIG. 11.

FIG. 13 is a perspective view of a consumer product made from the coated articles in the kit of FIG. 10.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

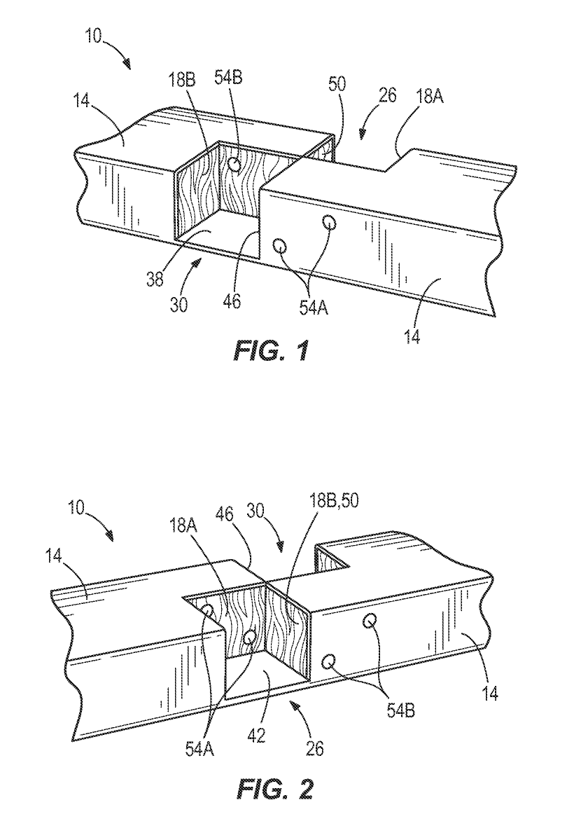

With reference to FIGS. 1 and 2, a coated article 10 includes a first substrate 18A and a second substrate 18B that are connected with a polymer coating 14. The article 10 also includes uncoated portions 46, 50 of the respective substrates 18A, 18B adjacent first and second web portions 38, 42 of the coating 14. In the illustrated embodiment of the article 10, holes 54A, 54B are provided in the first substrate 18A and second substrate 18B, respectively, for assembling the coated article 10 as described in further detail below.

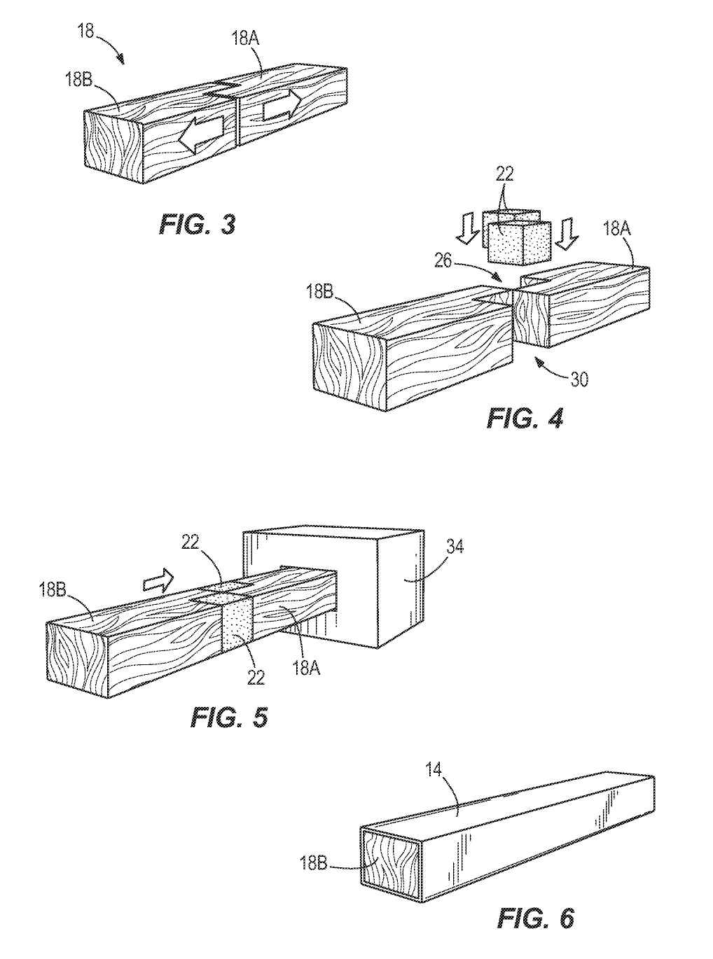

With reference to FIGS. 3-8, a method of manufacturing the coated article 10 is shown. FIG. 3 illustrates the first step in the process of providing a substrate 18, which can be wood, metal, or another suitable material, cutting the substrate 18 along a jogged line, and separating the substrate 18 into the resulting first substrate 18A and a second substrate 18B. Cutting the substrate 18 along a jogged line creates a first cutout 26 within the first substrate 18A and a second cutout 30 formed in the second substrate 18B. Two metal spacers 22 are then inserted adjacent the substrates 18A, 18B within the cutouts 26, 30 formed between the separated substrate pieces 18A, 18B (FIG. 4). Although the spacers 22 have been described as metal, spacers made of any suitable material (e.g., a non-porous material) to which the polymer coating will not stick could alternatively be used.

The substrates 18A, 18B and the spacers 22 are subsequently fed through a die 34 (FIG. 5) in which the polymer coating 14 is applied to encapsulate the substrate pieces 18A, 18B and the spacers 22 (FIG. 6). The polymer coating 14 is applied to contiguously coat the first substrate 18A, both the spacers 22, and the second substrate 18B. The die 34 illustrated is similar to the apparatus and method disclosed in U.S. Pat. No. 6,660,086, the contents of which are incorporated herein by reference. Alternatively, the polymer coating 14 may be applied to the substrates 18A, 18B in another manner.

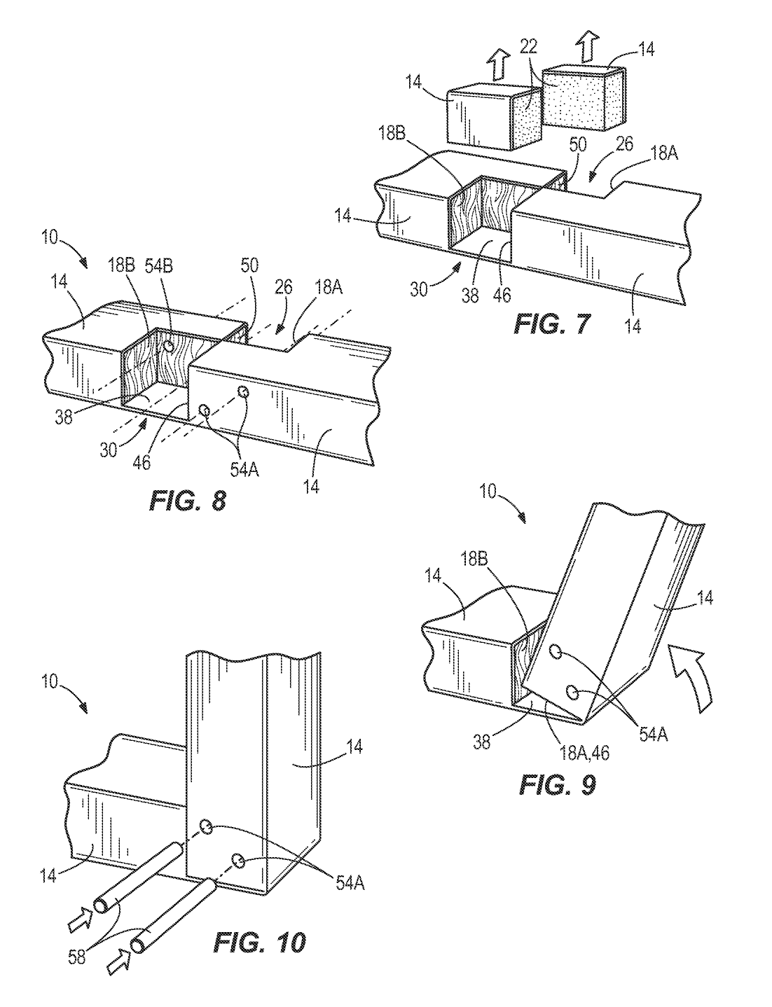

With reference to FIG. 7, the polymer-coated spacers 22 are removed, thereby leaving the first and second substrate 18A, 18B interconnected only by the first web portion 38 and the second web portion 42 of the polymer coating 14. Removing the polymer-coated spacers 22 creates the first web portion 38 and the second web portion 42 of the polymer coating 14 unassociated with the first and second substrates 18A, 18B. Removing the spacers 22 by cutting out sections of the polymer coating 14 is a more effective method of creating precision forms that post-coating machining or routing a contiguous coated substrate. In the illustrated embodiment, the first and second substrates 18A, 18B are interconnected solely with the first web portion 38 and the second web portion 42. When the polymer-coated spacers 22 are removed, the first uncoated portion 46 and the second uncoated portion 50 of the substrates 18A, 18B become exposed. Holes 54A, 54B are then bored through at least a portion of the polymer coating 14 and the substrates 18A, 18B (FIG. 8) by drilling or using another suitable method.

With reference to FIGS. 9-10, an exemplary assembly process of the coated article 10 is illustrated. After the polymer-coated spacers 22 are removed and the holes 54 are created, the first substrate 18A is reoriented relative to the second substrate 18B (FIG. 9) by folding the first substrate 18A relative to the second substrate 18B. In the illustrated embodiment of the article 10, the substrates 18A, 18B are movable between a first configuration (FIG. 8), in which the first substrate 18A and the second substrate 18B are collinear, and a second configuration (FIG. 10), in which the first substrate 18A and the second substrate 18B are non-collinear. The uncoated portions 46, 50 are adjacent the first web portion 38 and the second web portion 42, respectively, when the first and second substrates 18A, 18B are in the first configuration. And, the first web portion 38 and the second web portion 42 overlie the uncoated surfaces 46, 50, respectively, when the first and second substrates 18A, 18B are in the second configuration. In the illustrated embodiment, the uncoated portions 46, 50 are completely shrouded by the first web portion 38 and the second web portion 42 when the substrates 18A, 18B are in the second configuration. More specifically, the first web portion 38 overlies the first uncoated portion 46 and the second web portion 42 overlies the second uncoated portion 50 when the first and second substrates 18A, 18B are in the second configuration. Any further uncoated portions of the substrate 18A are shrouded by the adjacent substrate 18B, when in the second configuration. Likewise, any further uncoated portions of the substrate 18B are shrouded by the adjacent substrate 18A, when in the second configuration.

When the first substrate 18A is reoriented relative to the second substrate 18B, the holes 54A in the first substrate 18A become aligned with the holes 54B in the second substrate 18B. In the illustrated embodiment, the first substrate 18A is reoriented relative to the second substrate 18B by folding or pivoting the first substrate 18A approximately 90 degrees relative to the second substrate 18B. However, alternative reorientations between the first substrate 18A and second substrate 18B are also possible. For example, the substrate 18 may initially be cut (during the first step shown in FIG. 3) to ultimately form a 45 degree connection. After the first substrate 18A is reoriented relative to the second substrate 18B, fasteners 58 are inserted through the holes 54A, 54B to secure the first substrate 18A and the second substrate 18B together in the second configuration (FIG. 10). Once fastened together, no uncoated portions of either of the substrates 18A, 18B are visible or otherwise exposed.

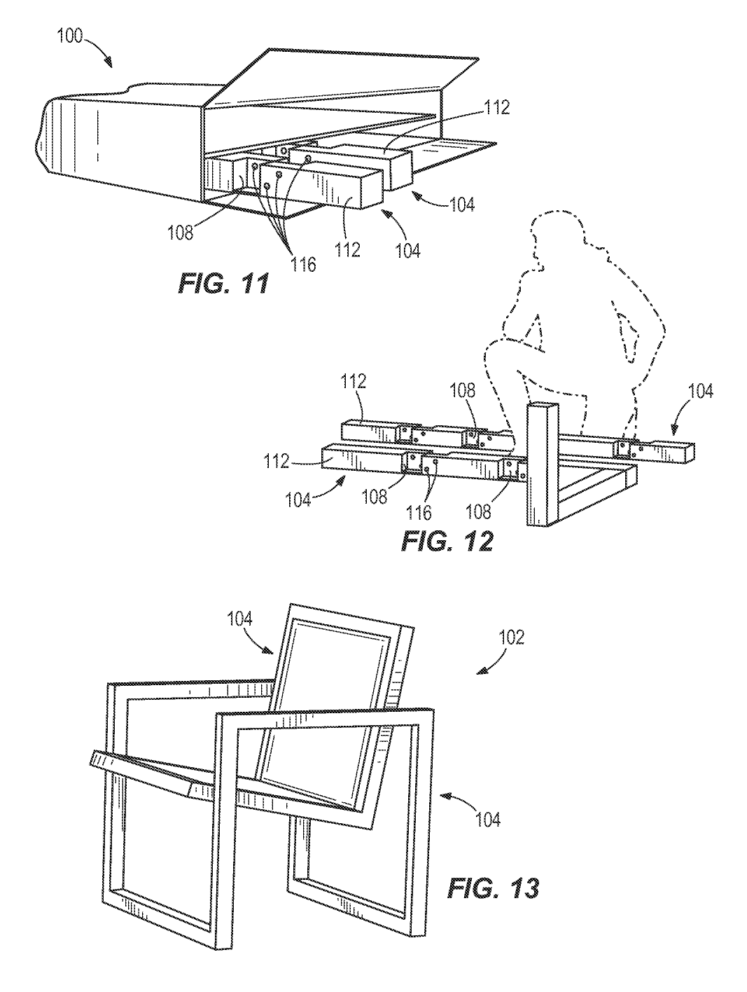

With reference to FIGS. 11-13, the above described process may be utilized to manufacture coated articles, similar to the coated article 10 shown in FIGS. 1 and 2, that are sold as a kit 100 for subsequent user assembly. Household or office furniture (e.g., a chair 102, FIG. 11) may be made from assembling coated articles 104 manufactured using this process. More specifically, the coated articles 104 can include a plurality of substrate pieces 108 held together with a contiguous polymer coating 112, and can be packaged and shipped in a first configuration (FIG. 11) with the substrate pieces 108 oriented collinearly or flat. Packaging the coated articles 104 in the first configuration, with the substrates 108 oriented collinearly, reduces the packaging size required and therefore overall cost of the kit 100. The user can then remove the coated articles 104 from the packaging and begin assembling the kit 100. Assembling the kit 100 includes moving the plurality of substrates 108 from the first configuration to a second, non-collinear configuration. In the illustrated embodiment, the coated articles 104 are packaged with holes 116 pre-drilled to facilitate assembly by the end user. With reference to FIG. 11, the chair 102 fully assembled includes coated articles 104 with reoriented substrates 108 that are fastened together. The assembled coated articles 104 include no uncovered or exposed portions of any of the substrates 108. In other words, only the polymer coating 112 is visible and none of the substrates 108 are seen when in the second configuration (i.e., an assembled configuration). Although, the chair 102 is the illustrated example, other types of pre-constructed furniture (e.g., beds, dressers, etc.) could also be manufactured and assembled using the disclosed process.

Various features and advantages of the invention are set forth in the following claims.

What is claimed is:

1. A method of manufacturing a coated article, the method comprising:
providing a substrate;
positioning a spacer adjacent the substrate;
applying a polymer coating to the spacer and the substrate; and
removing the polymer-coated spacer to expose an uncoated portion of the substrate.

2. The method of claim 1, further comprising boring an aperture through at least a portion of the polymer coating and the substrate.

3. The method of claim 1, wherein the substrate is a first substrate, and wherein the method further includes
providing a second substrate adjacent the spacer; and
applying the polymer coating to the second substrate contiguously with the spacer and the first substrate.

4. The method of claim 3, wherein the spacer is a first spacer, and wherein the method further includes
positioning a second spacer between the first substrate and the second substrate;
applying the polymer coating to the second spacer contiguously with the first spacer, the first substrate, and the second substrate; and
removing the second polymer-coated spacer.

5. The method of claim 4, wherein positioning the first and second spacers includes
positioning the first spacer within a first cutout in the first substrate, and
positioning the second spacer within a second cutout in the second substrate.

6. The method of claim 3, further comprising reorienting the first substrate relative to the second substrate after the polymer-coated spacer is removed.

7. The method of claim 6, wherein reorienting the first substrate relative to the second substrate includes pivoting the first substrate approximately 90 degrees relative to the second substrate.

8. The method of claim 6, further comprising fastening the first substrate to the second substrate after reorienting the first substrate relative to the second substrate.

9. The method of claim 3, further comprising creating a web of the polymer coating unassociated with the first and second substrates in response to removing the polymer-coated spacer.

10. The method of claim 9, further comprising interconnecting the first and second substrates solely with the web.

11. The method of claim 9, further comprising:
reorienting the first substrate relative to the second substrate after the polymer-coated spacer is removed; and
covering the uncoated portion of the first substrate with the web.

12. A coated article comprising:
a first substrate;
a second substrate; and
a polymer coating covering the first substrate and the second substrate,
wherein a web of the polymer coating interconnects the first substrate and the second substrate.

13. The coated article of claim 12, wherein the first substrate and second substrate are movable between a first configuration, in which the first substrate and the second substrate are collinear, and a second configuration, in which the first substrate and second substrate are non-collinear.

14. The coated article of claim 13, wherein at least one of the first substrate and the second substrate includes an uncoated surface.

15. The coated article of claim 14, wherein the uncoated surface is adjacent the web when the first and second substrates are in the first configuration.

16. The coated article of claim 15, wherein the web overlies the uncoated surface when the first and second substrates are in the second configuration.

17. The coated article of claim 16, wherein the uncoated surface is completely shrouded by the web when the first and second substrates are in the second configuration.

18. The coated article of claim 16, wherein the uncoated surface is a first uncoated surface on one of the first and second substrates, wherein the web is a first web, and wherein the coated article further includes
a second web of the polymer coating interconnecting the first substrate and the second substrate, and
a second uncoated surface on one of the first and second substrates adjacent the second web when the first and second substrates are in the first configuration.

19. The coated article of claim 18, wherein the second web overlies the second uncoated surface when the first and second substrates are in the second configuration.

20. The coated article of claim 13, further comprising a fastener securing the first substrate and the second substrate in the second configuration.
